(19) United States
(12) Patent Application Publication
(10) Pub. No.: US 2025/0202377 A1
(43) Pub. Date: Jun. 19, 2025

(54) AC-TO-AC CONVERTER

(71) Applicant: Dyson Technology Limited, Malmesbury Wiltshire (GB)

(72) Inventors: Stephen GREETHAM, Gloucester (GB); Stephen BERRY, Swindon (GB)

(21) Appl. No.: 18/875,225

(22) PCT Filed: Jun. 15, 2023
(86) PCT No.: PCT/IB2023/056220

§ 371 Date: Dec. 16, 2024

(30) Foreign Application Priority Data
Jun. 16, 2022 (GB) 2208878.5

(51) Int. Cl. H02M 5/12; H02M 1/00; H02M 1/12; H02M 1/42; H02M 1/44; H02M 5/293; H02P 27/16

(52) U.S. Cl. CPC H02M 5/12; H02M 1/0009; H02M 1/126; H02M 1/4208; H02M 1/44; H02M 5/2932; H02P 27/16

(57) ABSTRACT

An AC-to-AC converter includes input terminals for connection to an AC source, output terminals for connection to a load, a transformer having a primary winding and a secondary winding, a primary-side switch, a pair of secondary-side switches, and a control circuit to control the switches. Closing the primary-side switch causes a primary current to be drawn from the AC source and through the primary winding to store energy in the transformer. Closing one of the secondary-side switches causes a secondary current to be output at the output terminals to transfer energy from the transformer to the load. The secondary current has the same polarity as the primary current when a first of the secondary-side switches is closed, and the opposite polarity when a second of the secondary-side switches is closed. The control circuit is operable to control the switches such that an alternating current is output at the output terminals.

### FIELD OF THE INVENTION

The present invention relates to an AC-to-AC converter.

### BACKGROUND OF THE INVENTION

An AC-to-AC converter may comprise a rectifier, a power factor correction (PFC) circuit, a DC-link capacitor, and an inverter. A problem with this arrangement is that the component count can be high. Additionally, a relatively high capacitance is often required for the DC-link capacitor.

### SUMMARY OF THE INVENTION

The present invention provides an AC-to-AC converter comprising: input terminals for connection to an AC source; output terminals for connection to a load; a transformer having a primary winding and a secondary winding; a primary-side switch connected between the input terminals and the primary winding; a pair of secondary-side switches connected between the output terminals and the secondary winding; and a control circuit to control the switches, wherein: the primary-side switch and the secondary-side switches are bi-directional; closing the primary-side switch causes a primary current to be drawn from the AC source and through the primary winding to store energy in the transformer; closing one of the secondary-side switches causes a secondary current to be output at the output terminals to transfer energy from the transformer to the load, the secondary current having the same polarity as the primary current when a first of the secondary-side switches is closed and the opposite polarity when a second of the secondary-side switches is closed; and the control circuit is operable to control the switches such that an alternating current is output at the output terminals.

The converter therefore provides AC-to-AC conversion without the need for a rectifier on the primary side or an inverter on the secondary side. As a result, AC-to-AC conversion can be achieved at a relatively low component count. Indeed, AC-to-AC conversion may be achieved with as few as three switches. This is made possible through the use of bi-directional switches, which can be controlled in both directions. That is to say that each of the switches can be made conductive and non-conductive in both directions. The primary-side switch may therefore be closed and, irrespective of the polarity of the AC source, a primary current may be drawn through the primary winding to store energy in the transformer. The secondary-side switches can then be controlled such that, irrespective of the polarity of the primary current, an alternating current is output at the output terminals.

In addition to a relatively low component count, the converter is capable of achieving AC-to-AC conversion with relatively little energy storage. In particular, the converter does not comprise an AC-to-DC stage and therefore does not require a DC-link capacitor. The converter may comprise an input filter on the primary side to smooth the input current drawn from the AC source and/or an output capacitor on the secondary side to smooth the output current at the output terminals. Nevertheless, the control circuit may employ a relatively high switching frequency for the switches such that the input filter and/or the output capacitor are required to store relatively little energy.

The converter acts as a current source. In particular, when one of the secondary-side switches is closed, a voltage is induced in the secondary winding that causes the secondary current to be output at the output terminals. The induced voltage is of sufficient magnitude that the secondary current is generated irrespective of any opposing voltage across the output terminals. Accordingly, the converter may be used to transfer power to loads that present an opposing voltage. For example, the converter may be used to power a permanent-magnet motor. As the rotor of a permanent-magnet motor rotates, a back EMF is induced in the phase winding(s). Consequently, when the output terminals of the converter are coupled to the phase winding, this back EMF is presented across the output terminals. The converter, in acting as a current source, is nevertheless capable of driving current and thus power into the phase winding irrespective of the magnitude of the back EMF.

The secondary-side switches may be connected in series to form a leg. A first end of the leg is then connected to a first end of the secondary winding, and a second end of the leg is connected to a second end of the secondary winding. In one arrangement, one of the output terminals may be connected to a midpoint of the leg, and another of the output terminals may be connected to a centre tap of the secondary winding. In another arrangement, the converter may comprise a further pair of secondary-side switches connected in series to form a further leg. A first end of the further leg is then connected to the first end of the secondary winding, a second end of the further leg is connected to the second end of the secondary winding, one of the output terminals is connected to a midpoint of the leg, and another of the output terminals is connected to a midpoint of the further leg. The former arrangement has the advantage of requiring just one pair of secondary-side switches, whilst the latter arrangement has the advantage of a simpler transformer (i.e., one having a non-tapped secondary winding).

Each of the secondary-side switches may comprise four states: (1) open, in which the switch does not conduct in either direction; (2) closed, in which the switch conducts in both directions; (3) a first diode mode, in which the switch conducts in a first direction only; and (4) a second diode mode, in which the switch conducts in a second direction only. The control circuit may then be operable to: close one of the secondary-side switches to output the secondary current; monitor a magnitude of the secondary current; and change the state of the secondary-side switch from closed to one of the diode modes when the magnitude of the secondary current is less than or equal to a threshold. By changing the state of the switch to diode mode when the secondary current drops to a threshold, reversal of the polarity of the secondary current may be avoided and thus the efficiency of the converter may be improved.

The control circuit may be operable to receive a signal indicative of a polarity of a voltage at the output terminals, and the control circuit may be operable to control the secondary-side switches such that the secondary current has the same polarity as the voltage. As noted above, the load may present an opposing voltage at the output terminals. By ensuring that the secondary current has the same polarity as the voltage at the output terminals, power may be transferred to the load irrespective of the voltage generated by the load at the output terminals.

The control circuit may be operable to control the switches such that, over a switching cycle, the switches are configured in: a first configuration in which the primary current is drawn from the AC source to store energy in the transformer; a second configuration in which the secondary current is output at the output terminals to transfer energy from the transformer to the load; and a third configuration in which energy in the transformer is freewheeled around a freewheel circuit or transferred from the transformer to a further load. As a result, the converter is capable of delivering unbalanced energy transfer. That is to say that the energy drawn from the AC source and stored in the transformer when the switches are in the first configuration may be different to the energy transferred from the transformer to the load when the switches are in the second configuration. The difference in energy is then managed by configuring the switches into the third configuration, which causes energy in the transformer to either freewheel around a freewheel circuit or be transferred to a different load. Employing unbalanced energy transfer enables the instantaneous output power to be shaped differently to that of the instantaneous input power. As a result, the efficiency of the converter may be improved. For example, the instantaneous output power may be better shaped so as to avoid or reduce excessive output currents, whilst the instantaneous input power may be shaped so as to achieve a good power factor.

The control circuit may be operable to: monitor the primary current; switch the switches from the first configuration to the second configuration when the primary current satisfies a first criterion; monitor the secondary current; and switch the switches from the second configuration to the third configuration when the secondary current satisfies a second criterion. As a result, both the input current and the output current, and thus the input power and the output power, may be independently shaped. In particular, the first configuration may be employed for an arbitrary period of time until the primary current satisfies the first criterion, and the second configuration may be employed for an arbitrary period of time until the secondary current satisfies the second criterion. These arbitrary periods of time, which together are shorter than the total period of the switching cycle, are made possible by the third configuration, which provides a path for residual energy stored in the transformer. The first criterion and the second criterion may then be defined such that particular profiles are achieved for the primary current (and thus the input current drawn from the AC source) and the secondary current (and thus the output current applied to the load).

The control circuit may be operable to switch the switches from the second configuration to the third configuration when an integral of the secondary current is greater than or equal to an average current reference. This form of current control may provide a better approximation to a desired profile (e.g., sinusoidal) for the output current.

The control circuit may be operable to switch the switches from the first configuration to the second configuration when an integral of the primary current is greater than or equal to an average current reference. As noted in the preceding paragraph, this form of current control may provide a better approximation to a desired profile (e.g., sinusoidal) for the input current. The control circuit may use the same form of current control (i.e., average current control) for both the input current and the output current.

The freewheel circuit may comprise one of the primary winding and the secondary winding. This then has the advantage that residual energy in the transformer may be managed in a cost-effective way. Additionally, in comparison to a freewheel circuit having an auxiliary winding, losses due to leakage inductance may be reduced.

The present invention also provides a motor system comprising an AC-to-AC converter as described in any one of the preceding paragraphs, and a permanent-magnet motor, wherein a phase winding of the permanent magnet motor is connected to the output terminals.

A conventional AC power supply for a permanent-magnet motor typically comprises a rectifier, PFC circuit and DC-link capacitor that output a stable DC voltage, and an inverter that converts the DC voltage into an AC voltage that is applied to the phase winding. In addition to having a relatively high component count and a high-capacitance DC-link capacitor, a problem with this arrangement is that it can be difficult to control the current and thus the power that is delivered to the motor. The magnitude of the back EMF induced in the phase winding, which acts in opposition to the applied voltage, varies with both position and speed of the rotor. It is therefore often necessary to employ a relatively complex scheme when controlling the inverter in order to ensure that the required current and power are driven into the phase winding. The present converter, on the other hand, acts as a current source. When one of the secondary-side switches is closed, a voltage is induced across the secondary winding that applies the secondary current to the phase winding irrespective of the magnitude of the back EMF. Consequently, in contrast to a conventional AC power supply, a much simpler control scheme may be used to drive current and power into the phase winding.

The control circuit may be operable to control the switches such that the alternating current at the output terminals has the same frequency as a back EMF induced in the phase winding. This then improves the efficiency of the motor system.

The control circuit may be operable to control the switches at a switching frequency higher than a frequency of a back EMF induced in the phase winding. This then has the advantage that the input current drawn from the AC source and/or the output current generated at the output terminals may be smoothed using smaller energy storage. If the transformer is not required to store any residual energy at the end of each switching cycle (e.g., because energy transfer is balanced, or because any residual energy is transferred to a different load), operating at a higher switching frequency has the further benefit that the transformer is required to store less energy, and therefore a smaller transformer may be employed.

The motor may output a signal indicative of a polarity of a back EMF induced in the phase winding, and the control circuit may be operable to receive the signal and to control the secondary-side switches such that the secondary current has the same polarity as the back EMF. This then improves the efficiency of the motor system.

The control circuit may monitor a speed of the motor and control the primary-side switch so as to adjust the amplitude of the primary current in response to changes in the speed of the motor. As a result, the input power and thus the output power may be adjusted in response to changes in the speed of the rotor. During start-up of the motor, the magnitude of the back EMF induced in the phase winding is relatively small. Consequently, for a given primary current, the secondary current will be relatively high. By adjusting the amplitude of primary current in response to changes in the speed of the motor, excessive secondary currents may be avoided.

### BRIEF DESCRIPTION OF THE DRAWINGS

FIG. 1 is a circuit diagram of a first example of an AC-to-AC converter;

FIG. 2 is a circuit diagram of a second example of an AC-to-AC converter;

FIG. 3 is a circuit diagram of a third example of an AC-to-AC converter;

FIG. 4 illustrates an example of the current in a transformer of the third AC-to-AC converter;

FIG. 5 is a circuit diagram of a fourth example of an AC-to-AC converter;

FIG. 6 is a circuit diagram of a fifth example of an AC-to-AC converter;

FIG. 7 is a circuit diagram of a sixth example of an AC-to-AC converter; and

FIG. 8 is a circuit diagram of a motor system.

### DETAILED DESCRIPTION OF THE INVENTION

The AC-to-AC converter 10 of FIG. 1 comprises input terminals 12,13, an input filter 14, a primary-side switch 20, a transformer 22, a pair of secondary-side switches 30,32, an output capacitor 40, output terminals 42,43, and a control circuit 50.

The input terminals 12,13 are connected to an AC source 60, and the output terminals 42,43 are connected to a load 70.

The input filter 14 smooths the current drawn from the AC source 60 and, in this example, comprises an inductor 16 and a capacitor 18.

The primary-side switch 20 and the secondary-side switches 30,32 are bi-directional switches (e.g., gallium nitride switches) that can be controlled in both directions. That is to say that each of the switches can be made conductive and non-conductive in both directions. The switches thus differ from, say, a MOSFET having a body diode which, although capable of conducting in both directions, can be made non-conductive in one direction only. In this particular example, each of the switches has four possible states: (1) open, in which the switch does not conduct in either direction; (2) closed, in which the switch conducts in both directions; (3) a first diode mode, in which the switch conducts in one direction only; and (4) a second diode mode, in which the switch conducts in the other direction only.

The transformer 22 comprises a primary winding 24 and a secondary winding 26. The secondary winding 26 is a centre-tapped winding having a first end 27, a second end 28, and a centre tap 29 located midway between the two ends 27,28.

The primary-side switch 20 and the primary winding 24 are connected in series between the input terminals 12,13. The secondary-side switches 30,32 are connected in series to form a leg. A first end of the leg is then connected to the first end 27 of the secondary winding 26, and a second end of the leg is connected to the second end 28 of the secondary winding 26. One of the output terminals 42 is connected to a midpoint of the leg (i.e., at a point between the two secondary-side switches 30,32), and the other of the output terminals 43 is connected to the centre tap 29 of the secondary winding 26.

The output capacitor 40 is connected in parallel across the output terminals 42,43 and acts to smooth the current that is output at the output terminals 42,43, as described below in more detail.

The control circuit 50 is responsible for controlling the switches 20,30,32 and outputs gate signals to control the state of each of the switches 20,30,32. The control circuit 50 comprises a voltage sensor 52, a primary-side current sensor 54, and a secondary-side current sensor 56. The voltage sensor 52 provides a measure of the voltage of the AC source 60. The primary-side current sensor 54 provides a measure of the primary current in the primary winding 24, and the secondary-side current sensor 55 provides a measure of the secondary current in the secondary winding 26. The control circuit 50 then uses the sensor measurements to control the states of the switches 20,30,32.

Operation of the converter 10 will now be described.

For each switching cycle, the control circuit 50 begins by opening the secondary-side switches 30,32 and closing the primary-side switch 20. Closing the primary-side switch 20 causes a primary current to be drawn from the AC source 60 and through the primary winding 24. With the secondary-side switches 30,32 open, the primary current and therefore the magnetic flux in the transformer 22 increases, thereby storing energy in the transformer 22.

The control circuit 50 monitors the primary current. When the primary current meets a criterion (described below), the control circuit 50 opens the primary-side switch 20 and closes one of the secondary-side switches 30,32. This causes a secondary current to be output at the output terminals 42,43, thereby powering the load 70 and charging the output capacitor 40. Energy is therefore transferred from the transformer 22 to the load 70 (and the output capacitor 40), and the magnetic flux in the transformer 22 decreases.

The control circuit 50 monitors the secondary current. Should the secondary current decrease to zero, the control circuit 50 opens the secondary-side switch 30,32 to prevent reversal of the secondary current. Irrespective of magnitude of the secondary current, the control circuit 50 opens the secondary-side switches 30,32 and closes the primary-side switch 20 at the end of the switching cycle.

The control circuit 50 then repeats the above-described switching cycle.

When a first of the secondary-side switches 30 is closed, the secondary current has the same polarity as the primary current. Conversely, when a second of the secondary-side switches 32 is closed, the secondary current has the opposite polarity to the primary current. The control circuit 50 then controls the secondary-side switches 30,32 such that an alternating current is output at the output terminals 30,32. The primary current has the same polarity as the AC source 60. The control circuit 50 therefore controls the secondary-side switches 30,32 based on the polarity of the AC source 60, as determined by the voltage sensor 52.

As noted above, the control circuit 50 opens the primary-side switch 20 and closes one of the secondary-side switches 30,32 when the primary current meets a criterion. In one example, the criterion may be met when the instantaneous value of the primary current is greater than or equal to a peak primary current reference. In another example, the criterion may be met when the integral of the primary current is greater than or equal to an average primary current reference. The control circuit 50 may generate the primary current reference by scaling the signal, V_AC, of the voltage sensor 52. The primary current reference is therefore a sinusoid that is in phase with the voltage of the AC source 60. The input current drawn from the AC source 60 is therefore similarly sinusoidal in shape and in phase with the voltage of the AC source 60. As a result, a relatively good power factor may be achieved.

The control circuit 50 employs a switching cycle having a constant period and therefore a constant switching frequency. The fraction of the switching cycle during which the primary-side switch 20 is closed and energy is stored in the transformer 22 may be referred to as the on-time. The remainder of the switching cycle, during which the primary-side switch 20 is open and energy is transferred from the transformer 22, may be referred to as the off-time. During the off-time, the secondary-side switch 30,32 may be closed or open (e.g., should the secondary current decrease to zero).

The current reference used to regulate the primary current may be defined such that, over each and every switching cycle, all energy stored in the transformer 22 during the on-time is transferred from the transformer 22 during the off-time. As a result, the instantaneous input power drawn from the AC source 60 and the instantaneous output power driven into the load 70 are the same. Alternatively, the current reference may be defined such that, over a particular switching cycle, the energy stored in the transformer 22 during the on-time is greater or less than the energy transferred from the transformer 22 during the off-time. As a result, the instantaneous input power drawn from the AC source 60 and the instantaneous output power driven into the load 70 are different. The difference in instantaneous energy is then stored by the transformer 22. This then has the advantage that the output power may be shaped differently to that of the input power, whilst still maintaining a good power factor. The current reference used to regulate the primary current is nevertheless defined such that, over each cycle of the AC source 60, the total input power and the total output power are the same. As a result, the net energy stored by the transformer 22 over each cycle of the AC source 60 is zero.

The converter 10 resembles and operates in a similar manner to that of a flyback converter. In particular, the transformer 22 behaves as a coupled inductor and combines the functions of energy storage, energy transfer, and isolation. The two behaviours described in the preceding paragraph may be thought of as discontinuous and continuous conduction modes of a conventional flyback converter. However, with a conventional flyback converter, the instantaneous energy transfer is always balanced, even when operating in continuous conduction mode. That is to say that the energy stored during the on-time is the same as that transferred during the off-time. By contrast, with the converter 10 described here, the instantaneous energy transfer may be unbalanced. In particular, the energy stored during the on-time of a switching cycle may be greater or less than the energy transferred during the off-time.

A conventional flyback converter outputs a direct current, whereas the converter 10 described here outputs an alternating current. Moreover, the converter 10 provides AC-to-AC conversion without the need for a rectifier on the primary side or an inverter on the secondary side. As a result, AC-to-AC conversion is possible with a relatively low component count. This is made possible through the use of bi-directional switches 20,30,32 and the centre-tapped secondary winding 26. In particular, by employing bi-directional switches 30,32 and a centre-tapped winding 26 on the secondary side, an alternating current may be output at the output terminals 42,43 irrespective of the polarity of the primary current.

In addition to a relatively low component count, the converter 10 is capable of achieving AC-to-AC conversion with relatively little energy storage on the primary side or the secondary side. For example, the control circuit 50 may employ a relatively high switching frequency (e.g., kHz frequencies, such as between 40 and 150 kHz) such that the input filter 14 and the output capacitor 40 are required to store relatively little energy.

The converter 10 is not, however, without its disadvantages. In particular, the transformer 22 is required to store the electrical power that is transferred from the primary side to the secondary side. Consequently, as the required output power increases, the size of the transformer 22 must increase. The converter 10 is therefore particularly well-suited for loads of relatively low power, e.g., less than 200 W.

The amplitude of the primary current reference defines the amplitude of the input current and therefore the input power that is drawn from the AC source 60. The control circuit 50 may therefore adjust the amplitude of the primary current reference so as to control the input power and thus the output power of the converter 10. In some examples, the control circuit 50 may receive an input signal indicative of desired output power, and the control circuit 50 may control the amplitude of the primary current reference in response to the input signal.

The primary current reference employed by the control circuit 50 has a sinusoidal shape. In particular, the control circuit scales the V_AC signal in order to generate the primary current reference. As a result, the input current drawn by the converter 10 is substantially sinusoidal in shape and is in phase with the voltage of the AC source 60. This then has the advantage that a relatively high power factor may be achieved. However, a potential disadvantage of drawing a sinusoidal input current is that, for a given average input power, the peak input power and the peak input current are relatively high. The control circuit 50 may therefore employ a primary current reference having an alternative shape, in particular one that reduces the peak input power and/or the peak input current. For example, the control circuit 50 may employ a clipped sine or trapezoidal waveform for the primary current reference. This then has the benefit that the converter 10 may employ components rated for a lower current and/or a lower power. Any departure from a sinusoidal waveform will inevitably decrease the power factor and increase the harmonic content of the input current. Many countries have regulations (e.g., IEC61000-3-2) that impose strict limits on the harmonic content of the input current that may be drawn from a mains power supply. However, when the converter 10 is used to power a relatively low-power load, it may be possible to employ a waveform for the primary current reference that reduces the peak input power and/or the peak input current whilst remaining within the harmonic limits imposed by regulations.

When the secondary-side switch 30,32 is closed, the control circuit 50 monitors the secondary current and opens the secondary-side switch 30,32 should the secondary current decrease to zero. Delays between sensing the secondary current and opening the secondary-side switch 30,32 can mean that the secondary current transitions through zero and reverses polarity, which then reduces the efficiency of the converter 10. As noted above, each of the switches 20,30,32 is able to operate in a diode mode, in which the switch conducts in one direction only. This can then be used to avoid reversal of the secondary current. For example, the control circuit 50 may monitor the secondary current and, in the event that the secondary current is less than a threshold, the control circuit 50 may change the state of the closed secondary-side switch 30,32 to diode mode. As a result, the efficiency of the converter 10 may be improved.

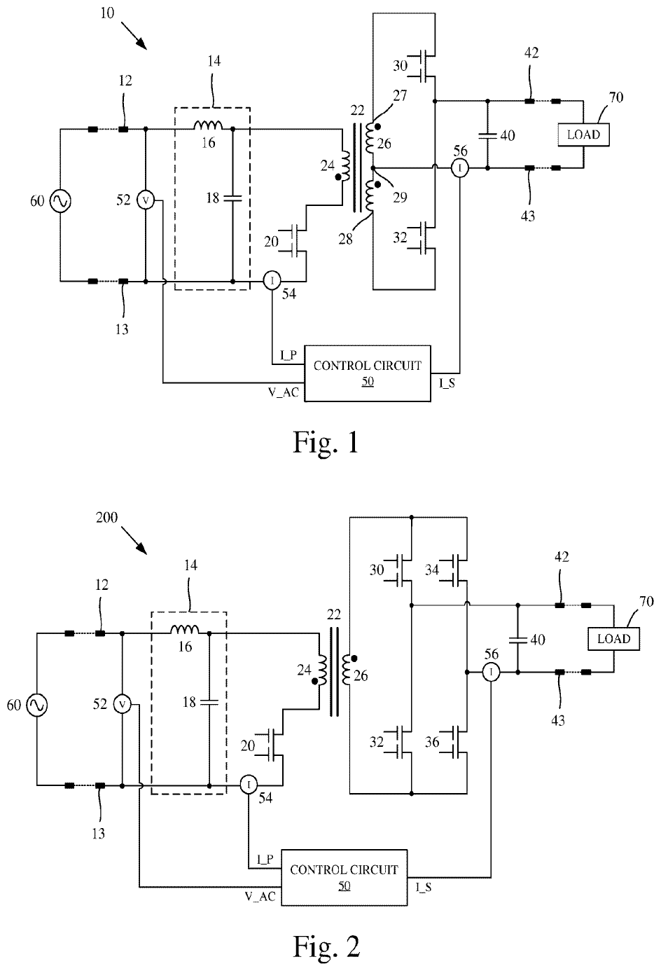

In the example described above, the secondary winding 26 is centre-tapped and the converter 10 comprises two secondary-side switches 30,32. FIG. 2 illustrates a second example of an AC-to-AC converter 200 in which the transformer 22 comprises a non-tapped secondary winding 26, and the converter 200 comprises a further pair of secondary-side switches 34,36. The further secondary-side switches 34,36 are connected in series to form a further leg. The two legs 30,32 and 34,36 are then arranged as an H-bridge with the output terminals 42,43 and the output capacitor 40 located at the centre. The manner in which the converter 200 operates is essentially unchanged from that described above. However, the control circuit 50 now closes two of the secondary-side switches 30,36 when transferring energy from the transformer 22. When a first pair of the secondary-side switches 30 and 36 are closed, the secondary current has the same polarity as the primary current. Conversely, when a second pair of the secondary-side switches 32 and 34 are closed, the secondary current has the opposite polarity to the primary current.

In both of the examples illustrated in FIGS. 1 and 2, the AC-to-AC converter 10,200 comprises a pair of secondary-side switches 30,32 that are connected in series to form a leg. One end of the leg is then connected to a first end 27 of the secondary winding 26, the other end of the leg is connected to a second end 28 of the secondary winding 26, and a midpoint of the leg is connected to one of the output terminals 42. In the example of FIG. 1, the other of the output terminals 43 is connected to a centre tap 29 of the secondary winding 26. In the example of FIG. 2, the converter 200 comprises a further pair of secondary-side switches 34,36 that are connected in series to form a further leg. One end of the further leg is then connected to the first end 27 of the secondary winding 26, the other end of the further leg is connected to the second end 28 of the secondary winding 26, and the midpoint of the further leg is connected to the other of the output terminals 43. The converter 10 of FIG. 1 has the advantage of fewer switches, whilst the converter 200 of FIG. 2 has the advantage of a simpler transformer.

Although not shown in the Figures, each of the example converters 10,200 comprises a snubber circuit located on the primary side of the transformer 22 to manage leakage inductance. Since the converters 10,200 do not comprise a rectifier on the primary side, the polarity of the primary current changes with each half-cycle of the input voltage. The diode of the snubber circuit is therefore replaced with a bi-directional switch operating in diode mode. The control circuit 50 then controls the snubber switch such that it operates in one of the two diode modes based on the polarity of the input voltage, as determined from the V_AC signal. For example, the snubber switch may operate in the first diode mode when the polarity of the input voltage is positive, and operate in the second diode mode when the polarity of the input voltage is negative.

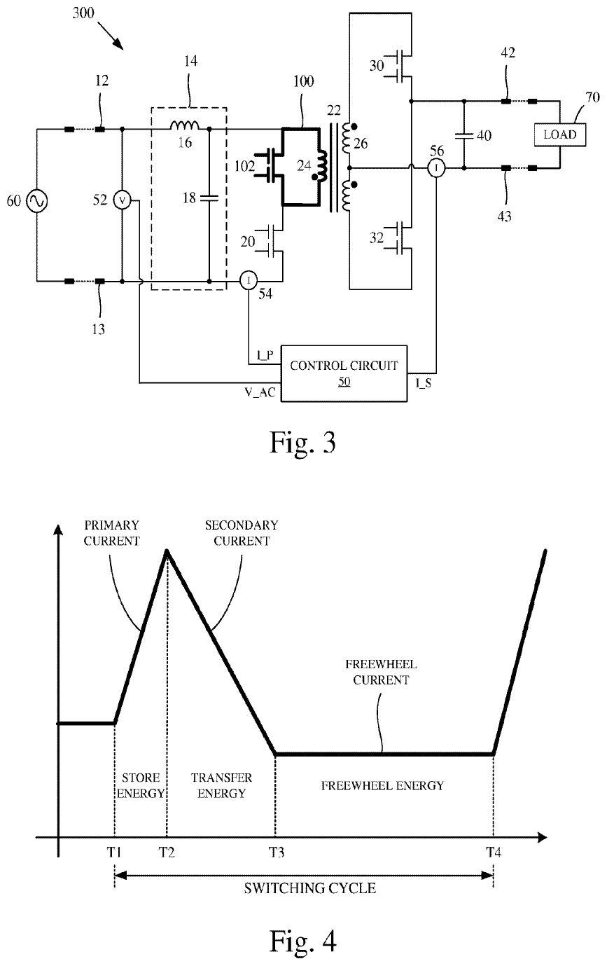

As noted above, instantaneous energy transfer from the primary side to the secondary side of the converter 10,200 may be unbalanced, with the difference in energy being stored in the transformer 22. This then has the benefit that the profile of the output power may be shaped differently to that of the input power. Nevertheless, the profile of the output power is still very much tied to that of the input power. It is not possible, for example, to arbitrarily shape the output current without adversely affecting the shape of the input current, which in turn adversely affects current harmonics and power factor. Consider, for example, a sinusoidal output current having a frequency higher than that of the input current. In order to achieve this, the zero-crossings in the output current would require switching cycles during which no energy is transferred from the transformer 22. This would then require the primary-side switch 20 to be closed for the full duration of the switching cycle, resulting in peaks in the input current at the frequency of the output current. An input filter 14 of significantly higher impedance would then be required to deal with this ripple. It is, however, possible to adapt the converters 10,100 such that the input current and the output current can be independently shaped, as will now be described with reference to FIGS. 3 to 7.

FIG. 3 illustrates a third example of a converter 300.

The converter 300 is unchanged from that illustrated in FIG. 1 with two exceptions. First, the converter 300 comprises a freewheel circuit 100. Second, the control circuit 50 of the converter 300 employs a secondary current reference to regulate the secondary current.

The freewheel circuit 100 is relatively simple and comprises a freewheel switch 102 connected in parallel with the primary winding 24. The freewheel circuit 100 is drawn in heavier line in FIG. 3 in order to better identify the circuit.

For each switching cycle, the control circuit 50 begins by opening the secondary-side switches 30,32 and the freewheel switch 102, and closing the primary-side switch 20. Closing the primary-side switch 20 causes a primary current to flow through the primary winding 24 to store energy in the transformer 22. The control circuit 50 monitors the primary current and, when the primary current meets a criterion (described above), the control circuit 50 opens the primary-side switch 20 and closes one of the secondary-side switches 30,32. A secondary current is then output at the output terminals 42,43 and energy is transferred from the transformer 22 to the load 70. The control circuit 50 monitors the secondary current and, when the secondary current meets a further criterion (described below), the control circuit 50 opens the secondary-side switch 30,32 and closes the freewheel switch 102. With the freewheel switch 102 closed, current and thus energy in the transformer 22 freewheels around the freewheel circuit 100. Finally, at the end of the switching cycle, the control circuit 50 opens the freewheel switch 102 and closes the primary-side switch 20.

FIG. 4 illustrates the current in the windings 24,26 of the transformer 22 over a switching cycle. At time T1, the primary-side switch 20 is closed (the secondary-side switches 30,32 and the freewheel switch 102 are opened) and current is drawn from the AC source 60. As a result, current in the primary winding 24 rises and energy is stored in the transformer 22. In this example, energy is already stored in the transformer 22 at time T1. Consequently, when the primary-side 20 switch is closed, the primary current rises from a non-zero starting value. At time T2, the primary-side switch 20 is opened and one of the secondary-switches 30,32 is closed. As a result, current flows in the secondary winding 26 and energy is transferred from the transformer 22. For the purposes of simplicity, the turns ratio (Np/Ns) of the transformer 22 is one. Consequently, the primary current and the secondary current have the same magnitude at time T2. The secondary current decreases with time as energy is transferred from the transformer 22 to the load 70. At time T3, the secondary-side switch 30,32 is opened and the freewheel switch 102 is closed. Current therefore freewheels around the freewheel circuit 100 until time T4, at which point the freewheel switch 102 is opened and the primary-side switch 20 is closed.

In the switching cycle illustrated in FIG. 4, the energy transferred from the transformer 22 when the secondary-side switch 30,32 is closed is greater than that stored when the primary-side switch 20 is closed. Consequently, the magnitude of the primary current at the end of the switching cycle (i.e., at time T4) is less than that at the start of the switching cycle (i.e., at time T1).

The control circuit 50 opens the secondary-side switch 30,32 and closes the freewheel switch 102 when the secondary current meets a criterion. In one example, the criterion may be met when the instantaneous value of the secondary current is less than or equal to a secondary current reference. In another example, the criterion may be met when the integral of the secondary current is greater than or equal to an average secondary current reference. In both examples, the secondary current reference may be defined such that a particular profile is obtained for the secondary current and therefore the output current generated at the output terminals 42,43.

The converter 300 is therefore able to shape both the input current and the output current. This is made possible by the freewheel circuit 100, which provides a path for residual energy stored in the transformer 22. As a result, the primary-side switch 20 and the secondary-side switches 30,32 may be opened when there is still energy in the transformer 22. Opening and closing of the secondary-side switches 30,32 are therefore decoupled from that of the primary-side switch 20. In particular, the primary-side switch 20 may be closed for a desired period of time such that the primary current satisfies a first criterion, and the secondary-side switch 30,32 may be closed for a desired period of time such that the secondary current satisfies a second criterion. As a result, both the input current and the output current may be independently shaped. The only requirement is that the input current and the output current are shaped such that, over each cycle of the AC source 60, the total input power (i.e., the total energy stored in the transformer 22 during the on-times) is the same as the total output power (i.e., the total energy that is transferred from the transformer 22 during the off-times). As a result, the net energy stored by the transformer 22 over each cycle of the AC source 60 is zero.

Again, although not shown in FIG. 3, the converter 300 comprises a snubber circuit connected in parallel with the primary winding 24, and thus in parallel with the freewheel switch 102. Whilst both the snubber circuit and the freewheel circuit 100 are used to manage energy in the transformer 22 and each comprises a bi-directional switch, the switches operate very differently. The snubber switch operates in diode mode only and changes state only once with each half-cycle of the input voltage. The freewheel switch 102, by contrast, changes state with each switching cycle. The freewheel switch 102 therefore operates at the same switching frequency as the primary-side switch 20 and the secondary-side switches 30,32.

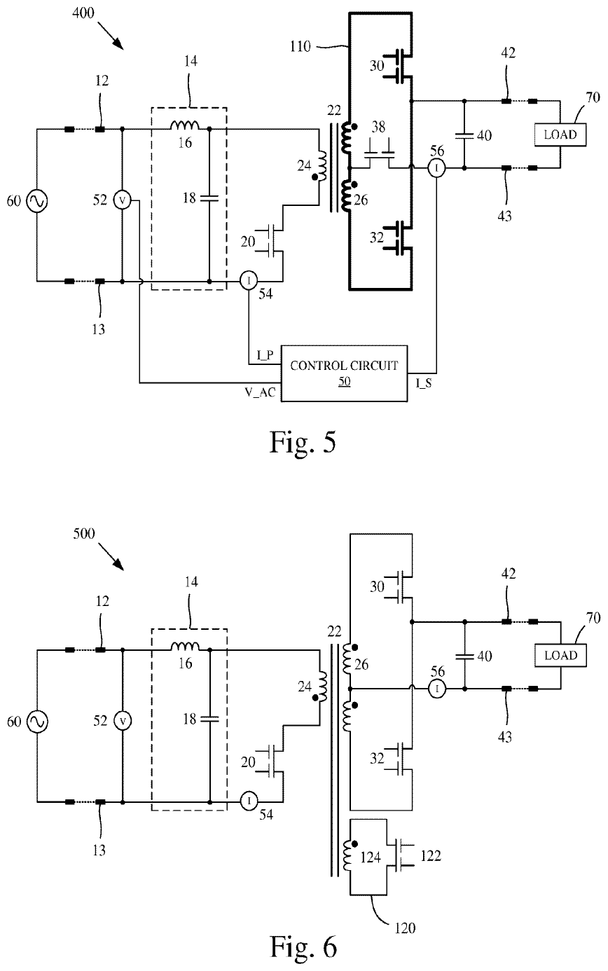

FIG. 5 illustrates a fourth example of a converter 400.

The converter 400 of FIG. 5 is similar to that described above and illustrated in FIG. 3. However, in contrast to the example of FIG. 3, energy in the transformer 22 freewheels around a freewheel circuit 110 that comprises the secondary winding 26 rather than the primary winding 24. Again, in order to better identify the freewheel circuit 110, the circuit is drawn in heavier line in FIG. 5.

The converter 400 comprises an additional secondary-side switch 38 connected between the centre tap 29 of the secondary winding 26 and the output terminal 43. In order to better distinguish the secondary-side switches 30,32,38 in the below discussion, the additional secondary-side switch 38 will be referred to as the common switch 38, and the other two secondary-side switches 30,32 will be referred to as the leg switches 30,32.

For each switching cycle, the control circuit 50 begins by opening the secondary-side switches 30,32,38, and closing the primary-side switch 20. Closing the primary-side switch 20 causes a primary current to flow through the primary winding 24 to store energy in the transformer 22. The control circuit 50 monitors the primary current and, when the primary current meets a criterion, the control circuit 50 opens the primary-side switch 20, closes the common switch 38 and one of the leg switches 30,32 on the secondary side. A secondary current is then output at the output terminals 42,43 and energy is transferred from the transformer 22 to the load 70. The control circuit 50 monitors the secondary current and, when the secondary current meets a further criterion, the control circuit 50 opens the common switch 38 and closes the other of the leg switches 20,32. With both leg switches 30,32 on the secondary side now closed, current and thus energy in the transformer 22 freewheels around a freewheel circuit 110 that comprises the secondary winding 26 and the two leg switches 30,32. Finally, at the end of the switching cycle, the control circuit 50 opens the leg switches 30,32 and closes the primary-side switch 20.

The particular configuration of the switches described in the preceding paragraph is just one example, and other configurations are possible that achieve the same behaviour. For example, one of the leg switches 30,32 may remain closed throughout the switching cycle. The choice of leg switch 30,32 that remains closed will depend on the desired polarity of the secondary current. The leg switch 30,32 may remain closed for a number of switching cycles, e.g., until such time as a change in the polarity of the secondary current is required. As a result, switching losses may be reduced, thereby improving the efficiency of the converter 400.

Operation of the converter 400 is therefore similar to that described above in connection with the example of FIG. 3. In particular, each switching cycle comprises a first period during which energy is stored in the transformer 22, a second period during which energy is transferred from the transformer 22, and a third period during which energy is freewheel in the transformer 22.

Freewheeling around the secondary side may also be achieved with the converter 200 of FIG. 2. As noted above, the secondary-side switches 30,32,34,36 of the converter 200 are arranged as an H-bridge. Energy is then transferred from the transformer 22 to the load 70 by closing a high-side switch 30,34 of one leg and a low-side switch 32,36 of the other leg. Energy in the transformer 22 is then freewheeled by closing both switches of one leg (e.g., switches 30 and 32) and opening both switches of the other leg (e.g., switches 34 and 36). Like the example of FIG. 5, energy in the transformer 22 then freewheels around a freewheel circuit that comprises the secondary winding 26 and the two closed switches (e.g., switches 30 and 32).

FIG. 6 illustrates a fifth example of a converter 500.

With the exception of the freewheel circuit 120, the converter 500 is unchanged from that of FIG. 3. The freewheel circuit 120 in this example comprises a freewheel switch 122 and an auxiliary winding 124 wound about the core of the transformer 22. The control circuit 50 controls the switches 20,30,32,122 in the same manner as that described above in connection with the converter 300 of FIG. 3. Accordingly, each switching cycle comprises a first period during which energy is stored in the transformer 22, a second period during which energy is transferred from the transformer 22, and a third period during which energy is freewheel in the transformer 22. In contrast to the examples of FIGS. 3 and 5, energy in the transformer 22 freewheels around the auxiliary winding 124, rather than the primary winding 24 or the secondary winding 26.

Whilst the provision of an auxiliary winding 124 is likely to increase leakage inductance, the auxiliary winding 124 may have a higher number of turns than the primary winding 24 and the secondary winding 26 such that a lower current freewheels around the freewheel circuit 120. As a result, an overall improvement in efficiency may be achieved.

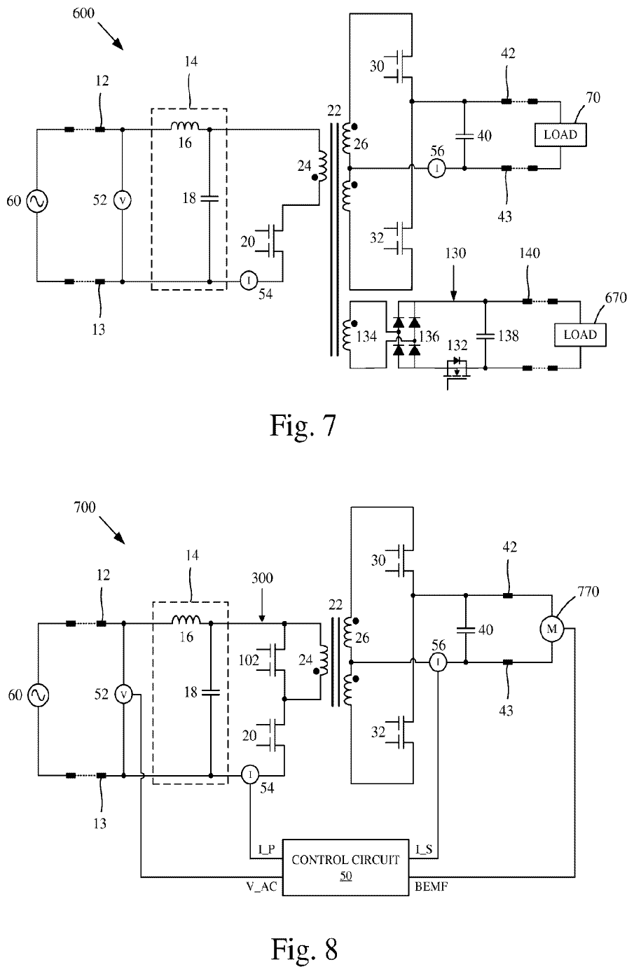

FIG. 7 illustrates a sixth example of a converter 600.

The converter 600 is similar to that illustrated in FIG. 6. However, the freewheel circuit 120 is replaced with an AC-to-DC circuit 130. The AC-to-DC circuit 130 comprise a switch 132, an auxiliary winding 134 wound about the core of the transformer 22, a bridge rectifier 136, a DC-link capacitor 138, and a pair of output terminals 140 for connection to a further load 670.

The switches 20,30,32,132 of the converter 600 are controlled in the same manner as that described above in connection with FIGS. 3 and 6, with the switch 132 of the AC-to-DC circuit 130 assuming the role of the freewheel switch 102,122. When the switch 132 of the AC-to-DC circuit 130 is closed, a current is induced in the auxiliary winding 134. This current is then rectified by the bridge rectifier 136 and charges the DC-link capacitor 138. As a result, a DC voltage is output at the output terminals 140. The converter 600 therefore serves as both an AC and a DC power supply. In particular, the converter 600 supplies an alternating current to the load 70, and a direct current to the further load 670.

In this example, a bridge rectifier 136 is used to rectify the current induced in the auxiliary winding 134. As a result, the switch 132 need not be a bi-directional switch and in this example is a MOFSET. It will be appreciated that other topologies of AC-to-DC circuit are possible. By way of example only, the auxiliary winding 134 may be centre tapped, and the bridge rectifier 136 may be replaced with a pair of opposing diodes connected in series to form a diode leg. One end of the diode leg is then connected to one end of the auxiliary winding, and the other end of the diode leg is connected to the other end of the auxiliary winding. One of the output terminals 140 of the AC-to-DC circuit 130 is then connected to the centre tap of the auxiliary winding 134, and the other of the output terminals 140 is connected to a midpoint of the diode leg.

Each of the converters 300,400,600 illustrated in FIGS. 3, 5 and 6 comprises a freewheel circuit 100,110,120 around which residual energy in the transformer 22 freewheels. By contrast, the converter 600 of FIG. 7 comprises an AC-to-DC circuit 130 that transfers residual energy from the transformer 22 to a further load 670. Each of the converters nevertheless manages the residual energy in the transformer 22 such that the input current and the output current may be shaped independently.

Common to each of these converters 300,400,600,700 is the manner in which the switches of the converter are controlled. In particular, the control circuit 50 controls the switches such that, over each switching cycle, the switches are configured in: (i) a first configuration in which a primary current is drawn from the AC source to store energy in the transformer 22; (ii) a second configuration in which a secondary current is output at the output terminals 42,43 to transfer energy from the transformer 22 to the load 70; and (iii) a third configuration in which residual energy in the transformer 22 is freewheeled around a freewheel circuit 100, 110, 120 or transferred from the transformer 22 to a further load 670. The control circuit 50 monitors the primary current and switches the switches from the first configuration to the second configuration when the primary current satisfies a first criterion. The control circuit 50 then monitors the secondary current and switches the switches from the second configuration to the third configuration when the secondary current satisfies a second criterion.

FIG. 8 illustrates a motor system 700 that comprises the converter 300 of FIG. 3 and a permanent-magnet motor 770.

The motor 770 comprises a phase winding connected to the output terminals 42,43 of the converter 300. The motor 770 outputs a signal, BEMF, indicative of the back EMF induced in the phase winding. For example, the motor 770 may comprise a position sensor (e.g., Hall-effect sensor or optical encoder) that outputs a signal indicative of the speed and position of the rotor, from which the back EMF induced in the phase winding may be inferred. In another example, the motor 770 may comprise an auxiliary winding that outputs a signal indicative of the back EMF induced in the auxiliary winding, which may then be used to infer the back EMF induced in the phase winding.

The control circuit 50 then uses the BEMF signal output by the motor 770 to control the switches 20,30,32,102. In particular, the control circuit 50 controls the secondary-side switches 30,32 such that the output current has the same polarity as that of the back EMF induced in the phase current. The choice of which secondary-side switch 30,32 to close therefore depends on the polarity of the input voltage and the polarity of the back EMF. The control circuit 50 employs a secondary current reference that matches the shape of and is in phase with the back EMF. As a result, that output current that is driven into the phase winding of the motor 770 has the same shape and phase as the back EMF. This then maximises the efficiency of the motor system 700 since the torque per ampere is at a maximum when the waveform of the phase current matches that of the back EMF.

A conventional AC power supply for a permanent-magnet motor typically comprises a rectifier, PFC circuit and DC-link capacitor (i.e., a first stage) that output a stable DC voltage, and an inverter (i.e., second stage) that converts the DC voltage into an AC voltage that is applied to the phase winding. This arrangement has a relatively high component count and a relatively high capacitance is typically required for the DC-link capacitor. A further problem with this arrangement is that it can be difficult to control the current and thus the power that is delivered to the motor. The magnitude of the back EMF induced in the phase winding, which acts in opposition to the applied voltage, varies with both position and speed of the rotor. It is therefore often necessary to employ a relatively complex scheme when controlling the inverter in order to ensure that the required current and power are driven into the phase winding in an efficient way. The converter 300 described herein, on the other hand, acts as a current source. In particular, when a secondary-side switch 30,32 is closed, a voltage is induced across the secondary winding 26 that forces the secondary current to flow. Importantly, the induced voltage drives the secondary current irrespective of the magnitude of the back EMF across the output terminals 42,43. Consequently, in contrast to a conventional AC power supply, a much simpler control scheme may be used to drive current and power into the phase winding in an efficient way. In particular, by employing a secondary current reference that matches the back EMF, excessive phase currents can be avoided and the efficiency of the motor system 700 can be improved.

Whilst particular examples have thus far been described, it will be understood that various modifications may be made without departing from the scope of the invention as defined by the claims. By way of example only, each of the converters described above comprises an input filter and an output capacitor, which smooth the high-frequency ripple in the input current and the output current respectively. Nevertheless, it will be apparent from the above discussions that neither the input filter nor the output capacitor are essential to the primary function of the AC-to-AC converter, which is to output an alternating secondary current.

1. An AC-to-AC converter comprising:
input terminals for connection to an AC source;
output terminals for connection to a load;
a transformer having a primary winding and a secondary winding;
a primary-side switch connected between the input terminals and the primary winding;
a pair of secondary-side switches connected between the output terminals and the secondary winding; and
a control circuit to control the switches,
wherein:
the primary-side switch and the secondary-side switches are bi-directional;
closing the primary-side switch causes a primary current to be drawn from the AC source and through the primary winding to store energy in the transformer;
closing one of the secondary-side switches causes a secondary current to be output at the output terminals to transfer energy from the transformer to the load, the secondary current having the same polarity as the primary current when a first of the secondary-side switches is closed and the opposite polarity when a second of the secondary-side switches is closed; and
the control circuit is operable to control the switches such that an alternating current is output at the output terminals.

2. The AC-to-AC converter as claimed in claim 1, wherein the control circuit is operable to control the switches such that, over a switching cycle, the switches are configured in:
a first configuration in which the primary current is drawn from the AC source to store energy in the transformer;
a second configuration in which the secondary current is output at the output terminals to transfer energy from the transformer to the load; and
a third configuration in which energy in the transformer is freewheeled around a freewheel circuit or transferred from the transformer to a further load.

3. The AC-to-AC converter as claimed in claim 2, wherein the control circuit is operable to:
monitor the primary current;
switch the switches from the first configuration to the second configuration when the primary current satisfies a first criterion;
monitor the secondary current; and
switch the switches from the second configuration to the third configuration when the secondary current satisfies a second criterion.

4. The AC-to-AC converter as claimed in claim 3, wherein the control circuit is operable to switch the switches from the second configuration to the third configuration when an integral of the secondary current is greater than or equal to an average current reference.

5. The AC-to-AC converter as claimed in claim 2, wherein the freewheel circuit comprises one of the primary winding and the secondary winding.

6. The AC-to-AC converter as claimed in claim 1, wherein the secondary-side switches are connected in series to form a leg, a first end of the leg is connected to a first end of the secondary winding, a second end of the leg is connected to a second end of the secondary winding, one of the output terminals is connected to a midpoint of the leg, and another of the output terminals is connected to a centre tap of the secondary winding.

7. The AC-to-AC converter as claimed in claim 1, wherein each of the secondary-side switches comprises four states: (1) open, in which the switch does not conduct in a first direction or a second direction; (2) closed, in which the switch conducts in both the first direction and the second direction; (3) a first diode mode, in which the switch conducts in the first direction only; and (4) a second diode mode, in which the switch conducts in the second direction only; and the control circuit is operable to:
close one of the secondary-side switches to output the secondary current;
monitor a magnitude of the secondary current; and
change the state of the secondary-side switch from closed to one of the diode modes when the magnitude of the secondary current is less than or equal to a threshold.

8. The AC-to-AC converter as claimed in claim 1, wherein the control circuit is operable to receive a signal indicative of a polarity of a voltage at the output terminals, and the control circuit is operable to control the secondary-side switches such that the secondary current has the same polarity as the voltage.

9. A motor system comprising an AC-to-AC converter as claimed in claim 1, and a permanent-magnet motor, wherein a phase winding of the permanent magnet motor is connected to the output terminals.

10. The motor system as claimed in claim 9, wherein the control circuit is operable to control the switches such that the alternating current at the output terminals has the same frequency as a back EMF induced in the phase winding.

11. The motor system as claimed in claim 9, wherein the control circuit is operable to control the switches at a switching frequency higher than a frequency of a back EMF induced in the phase winding.

12. The motor system as claimed in claim 1, wherein the motor outputs a signal indicative of a polarity of a back EMF induced in the phase winding, and the control circuit is operable to receive the signal and to control the secondary-side switches such that the secondary current has the same polarity as the back EMF.

13. The motor system as claimed in claim 1, wherein the control circuit monitors a speed of the motor, and the control circuit controls the primary-side switch so as to adjust the amplitude of the primary current in response to changes in the speed of the motor.
